(19) United States
(12) Patent Application Publication
(10) Pub. No.: US 2011/0103540 A1
(43) Pub. Date: May 5, 2011

(54) MULTIPLE BASE COUNTER REPRESENTATION

(76) Inventor: Gary M. WASSERMANN, Davis, CA (US)

(21) Appl. No.: 12/608,652

(22) Filed: Oct. 29, 2009

(51) Int. Cl. G06M 3/00

(52) U.S. Cl. 377/26; 377/1; 377/27

(57) ABSTRACT

A method comprises loading by logic a storage location with a count value. The count value comprises a plurality of upper order bits and a plurality of lower order bits. The method further comprises detecting, by said logic, an event and, based on detecting the event, sequentially changing the count value with the lower order bits changing according to base-1 counting and the upper order bits changing according to a counting scheme in which the upper order bits encode all possible binary values of the upper order bits.

### BACKGROUND

Many applications exist for digital counters. Counters are used to count a wide variety of events. An initial count value may be loaded into storage, such as Flash storage. Each time a specific event occurs, the stored count value is incremented or decremented depending on whether an up-counter or down-counter function is implemented. The count value comprises a series of bits, each bit being a logic 0 or a logic 1. Thus, as the count value is sequenced, various bits are changed from 0 to a 1 or from a 1 to a 0. Changing a bit from a 0 to a 1 is referred to as “setting” the bit. Changing a bit from a 1 to a 0 is referred to as “clearing” the bit.

For some types of storage, such as Flash storage, clearing a bit (1 to 0) can be accomplished relatively quickly and easily. However, setting a bit (0 to 1) requires reprogramming an entire sector which can take a substantially longer than clearing a bit. For example, reprogramming a sector might take on the order of seconds. Further, Flash storage has a finite lifespan that is measured in terms of the number of writes to the storage. Thus, storing a changing count value in Flash storage can cause the storage to wear out rapidly.

### BRIEF DESCRIPTION OF THE DRAWINGS

For a detailed description of exemplary embodiments of the invention, reference will now be made to the accompanying drawings in which:

FIG. 1 shows a system in accordance with various embodiments;

FIG. 2 shows a method in accordance with various embodiments; and

FIG. 3 shows the sequencing of a count value in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

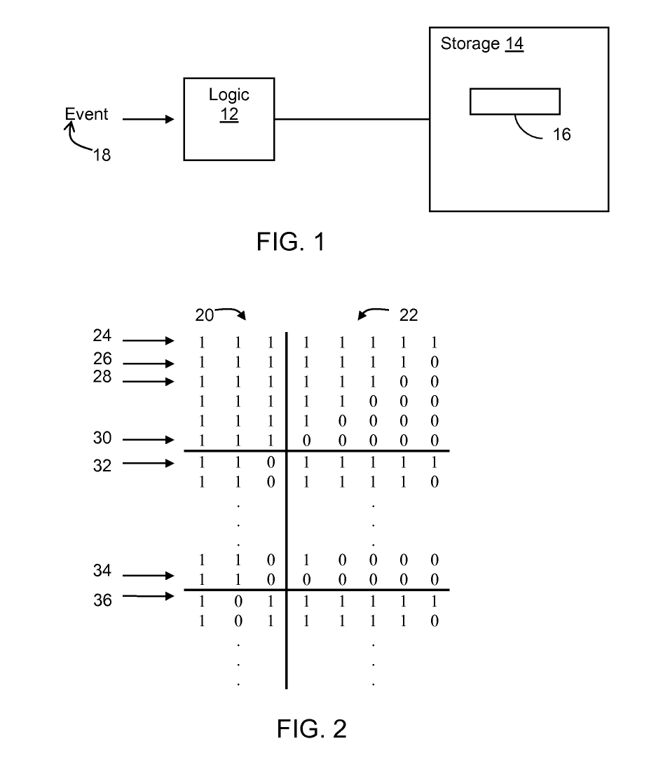

FIG. 1 shows a system 10 in accordance with various embodiments. As shown, system 10 comprises logic 12 coupled to storage 14. Logic 12 may comprises a processor or other logic devices. Storage 14 may comprise non-volatile storage (e.g., random access memory), non-volatile storage (e.g., Flash storage, read-only memory (ROM), hard disk drive, etc.), or combinations thereof. Logic 12 stores and updates a count value 16 in storage 14.

In accordance with various embodiments, logic 12 loads in initial count value 16 into storage 14. Upon detection of an event 18, the logic 12 changes the count value in a manner explained below. Each time the event 18 is detected, the logic 12 changes the count value. Thus, the logic 12 sequentially changes the count value based on a detection of the events 18.

An event 18 can be any type of event that is deemed desirable for counting. For example, the event may comprise the passage of time such as the number of hours or days that have passed since a finite time period license began. By way of an additional example, the event may be the number of data packets that pass through a given point in a system (e.g., number of packets through a given port in a network).

FIG. 2 an exemplary sequential change of count value 16. The count value 16 comprises a multi-bit value that includes a plurality of upper order bits 20 and a plurality of lower order bits 22. In the embodiment of FIG. 2, there are three upper order bits 20 and five lower order bits 22. However, the number of upper and lower order bits 20, 22, as well as the total number of bits in the count value 16, can be varied from that shown in FIG. 2.

In accordance with various embodiments, the upper order bits 20 are used in a counting scheme in which the upper order bits encode all possible binary values of the upper order bits. In some embodiments, the upper order bits 20 represent a base-2 counter and the lower order bits 22 represent a base-1 counter. Thus, the count value 16 is actually a combination of counter values that are sequentially changed in accordance with two different base number systems (base 2 and base 1 in the example depicted in FIG. 2).

FIG. 2 illustrates the sequence by which the logic 12 changes the count value 16. The sequence shown in FIG. 2 represents one suitable sequence, and other sequences are possible as well. An initial count value is loaded into storage 14. The initial count value in the example of FIG. 2 is depicted at 24 by all 1's (111 11111). That is, all three upper order bits 20 are logic 1's as are all five of the lower bits 22. At 26, upon detecting an event the lower order bits are decremented by 1 in accordance with base 1 counting. As a result, the count value is 111 11110 (the least significant bit is now a logic 0). After the next detected event, the count value is again changed. At 28, the lower order bits again are decremented by 1 in accordance with base 1 counting. As a result, the count value is 111 11100 (the least significant two bits are now 0's).

This process continues, with the lower order bits being sequenced according to a base 1 counting scheme, until state 30 is reached. At 30, the count value is 111 00000 with all five lower bits being 0. Once the next event 18 is detected, the upper order bits 20 then are changed. The upper order bits were 111 and now are decremented to 110 in accordance with a base-2 counting scheme. Thus, 32 represents the count value with the upper order bits decremented to 110 and the lower order bits being reset to all 1's (count value being 110 11111). The base-1 decrementing process explained above then repeats itself through state 34 at which time the count value is 110 00000.

Upon the next event being detected, the upper order bits at 36 are decremented in accordance with base-2 counting to 101 and the lower order bits are reset to all 1's. The process of decrementing the lower order bits 22 in accordance with base-1 counting again repeats itself.

Once the count value 16 reaches a terminal count value such as 000 00000 (all 0's), a suitable action can be taken by logic 12. For example, if the passage of time for a time-dependent license has expired, the underlying licensed product or service may be deactivated or an alert sent to the licensee or licensor to renew the license.

As illustrated above, the upper order bits 20 are encoded in at least some embodiments so that such bits can transition through all possible bit patterns given the number of upper order bits. For example, with three upper order bits, such bits can transition through 2³ (or 8) different values using base-2 counting. Further, the lower order bits 22 transition through a number of values that corresponds to one more than the number of lower order bits. For example, for five lower order bits, there are six different values possible using base-1 counting.

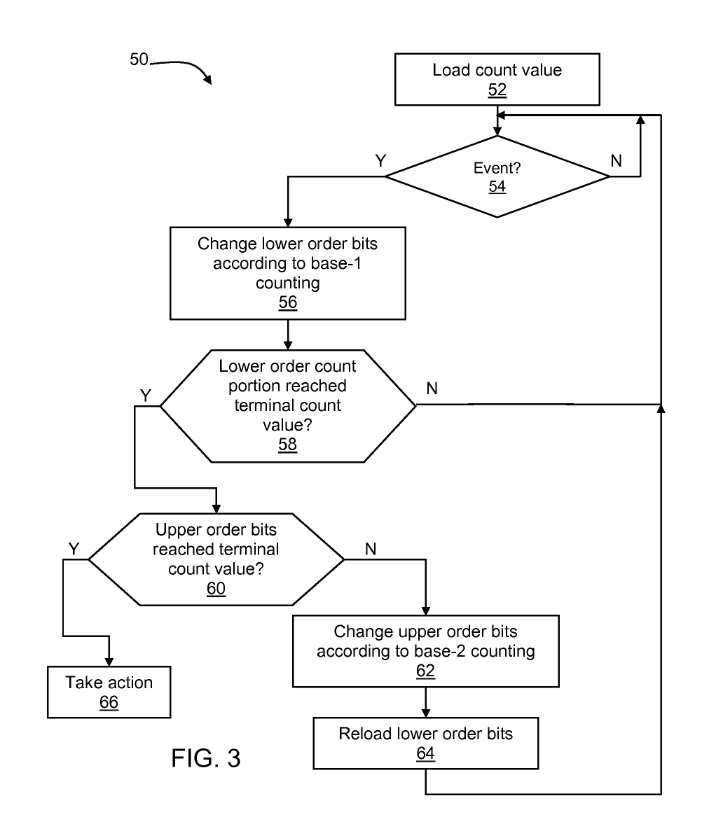

FIG. 3 depicts a method 50 in accordance with various embodiments. The method 50 is performed by, for example, logic 12. The various acts depicted in FIG. 3 can be performed in a different order and some of the acts may be performed in parallel as appropriate. At 52, the method comprises loading an initial count value 16 into storage 14. In the example of FIG. 2, the initial count value was 111 11111. At 54, the method comprises determining or detecting when an event 18 being counted as occurred. Once an event 18 is observed, the method comprises at 56 changing the lower order bits of the count value in accordance with base-1 counting. Changing such bits may comprise decrementing or incrementing as desired.

At 58, once the lower order bits are changed, the method comprises determining whether the lower order bit portion of the count value has reached a terminal count value. In the example of FIG. 2, the terminal count value of the lower order bit portion is all 0's (00000). If the lower order bits are not yet at their terminal count value, then control loops back to 54 at which the method waits for the next event to occur. In the example of FIG. 2, the terminal count value of the upper order bit portion is all 0's (000).

If, however, the lower order bits have reached their terminal count value, then at 60, the method comprises determining whether the upper order bit portion of the count value has reached a terminal count value. If the upper order bits are not yet at their terminal count value, then at 62 the upper order bit count value is changed (decremented or incremented as desired) in accordance with base-2 counting, and at 64 the lower order bits 22 are reloaded with their initial value (11111 in the example of FIG. 2). Control then loops back to 54 at which the method waits for the next event to occur.

However, at 60 if it is determined that the upper order bits 20 have reached their terminal count value (e.g., all 0's), then the lower order bits are also all 0's and thus the count value 16 has reached its terminal count (e.g., 000 00000). At this point, the method 50 comprises the logic 12 taking appropriate corrective action (66) as explained above.

Using a combination of base-1 and base-2 counting schemes, the logic 12 will have to set a bit (i.e., change bit from 0 to 1) less frequently than if, for example, a base-2 counter were used for all 8 bits. However, when some of the bits represent a base-1 counter, fewer count values are possible compared to a similarly-sized base-2 counter. An 8-bit base-2 counter can count through 256 states from 11111111 through 0000000. A count value having a combination of base-1 and base-2 counters is less efficient (in terms of number of count values possible) than a similarly sized base-2 counter, but advantageously results in fewer bits being set than a similarly sized base-2 counter. With the 8-bit counter shown in FIG. 2, there are 48 different count values from 111 11111 through 000 00000. The upper three bits sequence through 8 states from 111 to 000 and for each state, the five lower order bits sequence through 6 states from 11111 through 00000.

The logic 12 causes the count value to be changed in accordance with an up counter or a down counter. FIG. 2 depicts a down counter, but an up counter can be implemented as well. Further, the assignment of bit patterns is somewhat arbitrary so that the same sequence of bit patterns may represent an up-counter or a down-counter.

In the example of FIG. 2, there are five lower order bits 22 that sequence through six states from 11111 through 00000. As such, when determining what should be the initial count value to be loaded by the logic 12 into storage 14, any multiple of six will cause all five lower order bits to be 1's with the upper order bits depicting an integer multiple of six. For example, if it is desired to count six times, then the initial count value should be 000 11111 with an 8-bit counter with 3 upper order base-2 counting bits and 5 lower order base-1 counting bits. If it is desired to count twelve times, then the initial count value should be 001 11111. If, for example, a count of 13 is desired, then the initial count value should be 010 00000.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
loading, by logic, a storage location with a count value, said count value comprising a plurality of upper order bits and a plurality of lower order bits;
detecting, by said logic, an event;
based on detecting said event, sequentially changing, by said logic, said count value with the lower order bits changing according to base-1 counting and the upper order bits changing according to a counting scheme in which said upper order bits encode all possible binary values of said upper order bits.

2. The method of claim 1 wherein sequentially changing said count value comprises changing said lower order bits according to base-1 counting and the method then comprises determining whether the lower order bits have reached a first terminal count value.

3. The method of claim 2 wherein after the lower order bits are determined to have reached the terminal count value, the method comprises changing said upper order bits according to base-2 counting.

4. The method of claim 2 wherein after the lower order bits are determined to have reached the terminal count value, the method comprises determining whether the upper order bits have reached a second terminal count value.

5. The method of claim 4 wherein when the upper order bits are determined to have reached the second terminal count value, the method comprises taking a predetermined action.

6. The method of claim 4 wherein when the upper order bits are determined not to have reached the second terminal count value, the method comprises reloading said lower order bits with an initial value.

7. The method of claim 4 wherein when the upper order bits are determined not to have reached the second terminal count value, the method comprises changing said upper order bits according to base-2 counting.

8. The method of claim 7 wherein when the upper order bits are determined not to have reached the second terminal count value, the method also comprises reloading said lower order bits with an initial value.

9. A system, comprising:
storage containing a changeable count value, said count value comprising a plurality of upper order bits and a plurality of lower order bits; and
logic coupled to said storage, said logic sequentially changes the count value in said storage upon detection of an event, the lower order bits being changed according to base-1 counting and the upper order bits being changed according to a counting scheme in which said upper order bits encode all possible binary values of said upper order bits.

10. The system of claim 1 wherein said logic sequentially changes said count value according to base-1 counting and then determines whether the lower order bits have reached a first terminal count value.

11. The system of claim 10 wherein after the logic determines the lower order bits to have reached the first terminal count value, the logic changes said upper order bits according to base-2 counting.

12. The system of claim 10 wherein after the logic determines the lower order bits to have reached the first terminal count value, the logic determines whether the upper order bits have reached a second terminal count value.

13. The system of claim 12 wherein when the logic determines the upper order bits to have reached the second terminal count value, the logic causes a predetermined action to occur.

14. The system of claim 12 wherein when the logic determines the upper order bits not to have reached the second terminal count value, the logic reloads said lower order bits with an initial value.

15. The system of claim 12 wherein when the logic determines the upper order bits not to have reached the second terminal count value, the logic changes said upper order bits according to base-2 counting.

16. The system of claim 15 wherein when the logic determines the upper order bits not to have reached the second terminal count value, the logic also reloads said lower order bits with an initial value.

17. A system, comprising:
storage containing a changeable count value, said count value comprising a plurality of upper order bits and a plurality of lower order bits; and
logic coupled to said storage, said logic determines occurrences of an event, and upon said event occurrences said logic sequentially changes said lower order bits according to base-1 counting until a first terminal count value is reached, then changes said upper order bits according to base-2 counting.

18. The system of claim 17 wherein upon changing the upper order bits, said logic reloads the lower order bits to an initial state.
